(19) United States
(12) Patent Application Publication
(10) Pub. No.: US 2013/0305268 A1
(43) Pub. Date: Nov. 14, 2013

(54) OPTICAL PICKUP DEVICE

(71) Applicant: Panasonic Corporation, Osaka (JP)

(72) Inventors: Hirotaka UENO, Fukuoka (JP); Hiroshi Gotoh, Kumamoto (JP); Takashi Haruguchi, Fukuoka (JP); Takahiro Oomori, Fukuoka (JP); Tetsuya Nishio, Fukuoka (JP); Hideru Goto, Fukuoka (JP)

(73) Assignee: Panasonic Corporation, Osaka (JP)

(21) Appl. No.: 13/890,463

(22) Filed: May 9, 2013

(30) Foreign Application Priority Data
May 11, 2012 (JP) 2012-109108
May 25, 2012 (JP) 2012-119661

(51) Int. Cl. G11B 7/12

(52) U.S. Cl. CPC G11B 7/12
USPC 720/662

(57) ABSTRACT

An optical pickup device includes: a carriage moveably supported on an upper surface of a mount base and holding a light source, a light condensing member and optical components guiding the laser light from the light source to the light condensing member; a wiring member connected to the light source to supply electric power thereto; and a protection cover covering the upper surface of the mount base and a part of the wiring member and is provided with an opening through which the laser light passing through the light condensing member is irradiated onto the optical disk. The light source, light condensing member and optical components are located within a region obtained by projecting the opening in a direction perpendicular to a disk surface of the optical disk, and at least one of the light source, light condensing member and optical components protrudes into the opening in the protection cover.

### BACKGROUND OF THE INVENTION

1. Field of the Invention

The present invention relates to an optical pickup device to be incorporated in electronic devices such as personal computers, laptop computers and mobile terminal devices.

2. Description of the Related Art

There are a variety of types of optical disks such as BDs, DVDs, CD-Rs, CD-RWs, and so on. For BDs, laser light having a wavelength of about 405 nm is used to record or reproduce information on or from the optical disks. For DVDs, laser light having a wavelength of about 660 nm is used to record or reproduce information on or from the optical disks. Further, for CD-Rs and CD-RWs, laser light having a wavelength of about 780 nm is used to record or reproduce information on or from the optical disks. An optical pickup device capable of recording or reproducing information on or from such multiple types of optical disks has been proposed.

Meanwhile, development is being made recently to reduce the thickness of optical disk devices in accordance with reduction in thickness of laptop computers and mobile terminals.

To reduce the thickness of an optical pickup device, it is necessary to reduce the thickness of various components thereof, such as optical components and a light receiving element.

However, there is a limit to the reduction in thickness of the optical components, light receiving element, etc. and thus, it is difficult with this approach to further reduce the thickness of the optical pickup device.

### SUMMARY OF THE INVENTION

A primary object of the present invention is to provide an optical pickup device that enables reduction in thickness thereof.

To achieve the object, an optical pickup device according to an embodiment of the present invention includes: a mount base having an upper surface; a rotation drive unit mounted on the mount base and configured to hold and rotate an optical disk; a carriage supported on the upper surface of the mount base so as to be moveable radially relative to the optical disk held by the rotation drive unit; alight source mounted on the carriage and configured to emit laser light; alight condensing member mounted on the carriage and configured to condense the laser light onto the optical disk held by the rotation drive unit; a plurality of optical components mounted on the carriage so as to be located on an optical path from the light source to the light condensing member and configured to guide the laser light to the light condensing member; a wiring member that connects the light source with a power circuit to supply electric power to the light source; and a protection cover that covers the upper surface of the mount base and a part of the wiring member and is provided with an opening that allows the laser light passing through the light condensing member to be irradiated onto the optical disk through the opening, wherein the light source, the light condensing member and the optical components are located within a region obtained by projecting the opening in the protection cover in a direction perpendicular to a disk surface of the optical disk, and at least one of the light source, the light condensing member and the optical components protrudes into the opening in the protection cover.

### BRIEF DESCRIPTION OF THE DRAWINGS

Now the present invention is described in the following with reference to the appended drawings, in which:

FIG. 1 is a plan view showing an optical pickup device according to an embodiment of the present invention;

FIG. 2 is a fragmental side cross-sectional view of the optical pickup device;

FIG. 3 is a fragmental enlarged view of the optical pickup device;

FIG. 4 is a plan view showing an actuator of the optical pickup device;

FIG. 5 is s cross-sectional view of the actuator of the optical pickup device;

FIG. 6 is a perspective view showing the actuator of the optical pickup device;

FIG. 7 is a perspective view showing the optical pickup device; and

FIG. 8 is a drawing showing a structure of an optical pickup module.

### DETAILED DESCRIPTION OF THE PREFERRED EMBODIMENTS

Now, with reference to the appended drawings, description will be made of an optical pickup device according to the first embodiment of the present invention.

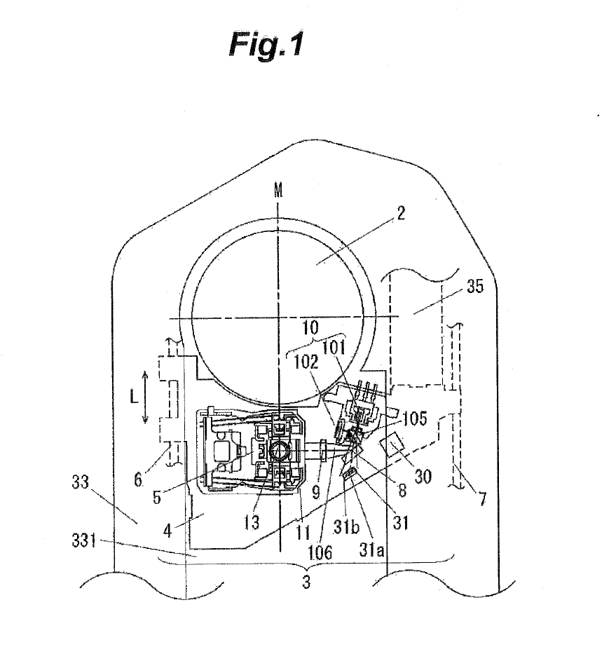

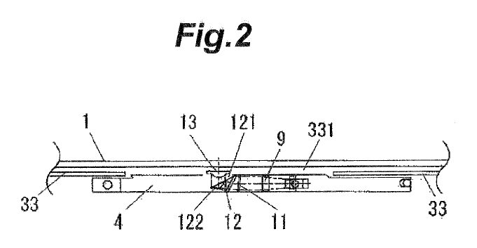

FIG. 1 is a plan view showing an optical pickup device according to the embodiment of the present invention, and FIG. 2 is a fragmental side cross-sectional view of the optical pickup device.

It is to be noted that a laser unit 101, an objective lens 13, a carriage 4, a wiring member 35 and an optical monitor 31 in this embodiment correspond to a light source, a light condensing member, a carriage, a wiring member and an optical monitor of the present invention, respectively. Further, a beam splitter 8, a collimating lens 9 and an erecting prism 12 shown in FIG. 1 correspond to a plurality of optical components of the present invention.

The optical pickup device includes an optical pickup 3 that irradiates light onto an optical disk 1 to perform at least one of reproduction of information from the optical disk 1 and recording of information on the optical disk 1. The optical disk 1 may be a read-only type in which only reproduction of information from the disk is possible, a recordable type in which recording of information on the disk is possible in addition to reproduction of information from the disk, or an erasable (or rewritable) type in which recording and erasing of information on the disk are possible in addition to reproduction of information from the disk. Read-only disks may include CD-ROMs, DVD-ROMs, BD-ROMs, and so on. Recordable disks may include CD-Rs, DVD-Rs, BD-Rs, and so on. Erasable disks may include CD-RWs, DVD-RWs, DVD-RAMS, BD-REs, and so on.

The optical disk 1 may include any of a recording layer for which substantially blue-purple light is used to perform at least one of recording of information thereon and reproduction of information therefrom, a recording layer for which substantially red light is used to perform at least one of recording of information thereon and reproduction of information therefrom, and a recording layer for which substantially infrared light is used to perform at least one of recording of information thereon and reproduction of information therefrom. The optical disk 1 may have a variety of diameters, though an optical disk having a diameter in a range from 3 to 12 cm is preferably used as the optical disk 1.

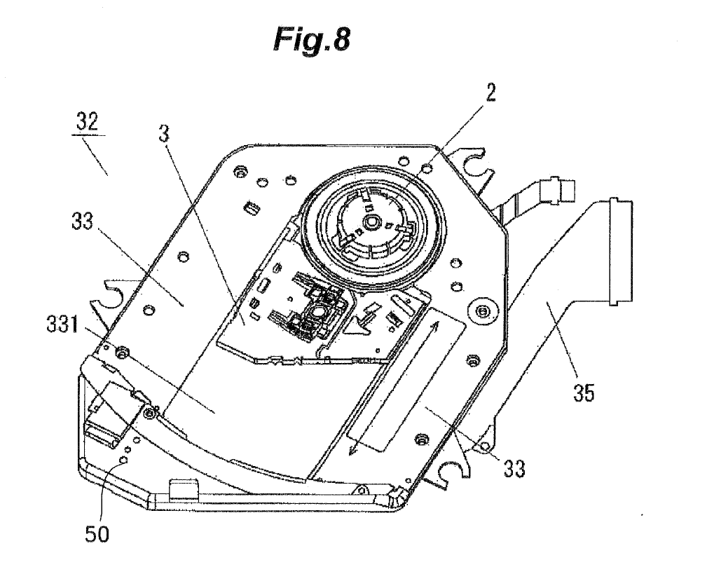

A spindle motor 2 is provided to rotate the optical disk 1. The spindle motor 2 is mounted on a mount base 50 (see FIG. 8) and is provided with a chucking part (not shown in the drawings) for holding the optical disk 1. The spindle motor 2 is capable of rotating the optical disk 1 at a constant angular velocity or at a varying angular velocity. Whether to control the angular velocity to be constant or to be varied is determined by a controller of a spindle motor drive unit and an optical disk device (not shown in the drawings) depending on the circumstances. It is to be noted that though the spindle motor 2 is used as a rotation drive unit for the optical disk 1 in the illustrated embodiment, the optical disk 1 may be rotated by use of a motor of another type or any other means.

The optical pickup 3 is provided with an objective lens 13 for condensing the laser light 106 onto the optical disk 1, and records and reproduces information on and from the optical disk 1 by irradiating light onto the optical disk 1.

The carriage 4 serves as a base of the optical pickup 3, and holds the laser unit 101, a light receiving element unit 102 and multiple optical components for guiding the laser light 106 from the laser unit 101 to the objective lens 13. The optical components include the collimating lens 9, the erecting prism 12, and so on.

An optical pickup actuator 5 is provided to move the objective lens 13 substantially three-dimensionally. The carriage 4 is supported by a support shaft 6 and a guide shaft 7 which are secured on an upper surface of the mount base 50, such that the carriage 4 is movable between an inner periphery and an outer periphery of the optical disk 1. The optical pickup actuator 5 and the light source (or an optical unit) are mounted on the carriage 4. As shown in FIG. 1, in this embodiment, the support shaft 6 is disposed on a side of the carriage 4 relatively close to the objective lens 13 while the guide shaft 7 is disposed on a side of the carriage 4 relatively close to the laser unit 101 such that the guide shaft 7 is laterally spaced apart from the laser unit 101.

The beam splitter 8 splits the incident laser light 106 such that a part of the laser light 106 is allowed to pass the beam splitter 8 toward an optical monitor 31 and the rest of the laser light 106 is guided toward the erecting prism 12. The optical monitor 31 monitors the output level of the laser light 106 based on the light received via the beam splitter 8.

The collimating lens 9 converts the diverging laser light 106 emitted from the laser unit 101 into substantially parallel light beams.

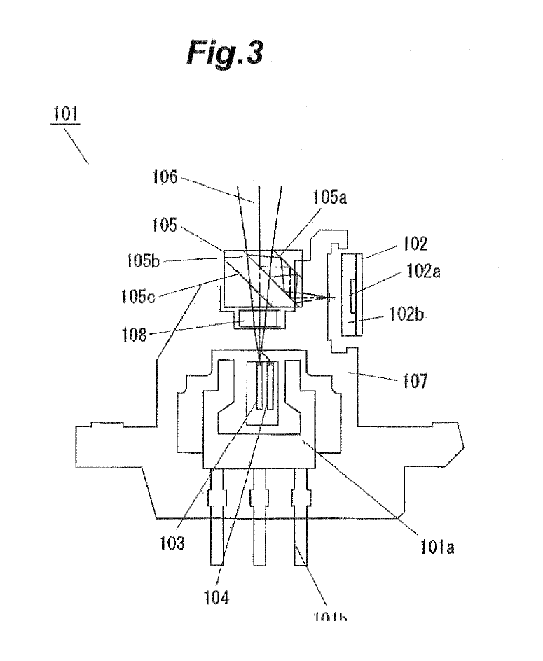

The laser unit 101, which emits red and infrared laser light, and the light receiving element unit 102, which receives the laser light, constitute an optical unit 10. Detailed description of the optical unit 10 will be provided later with reference to FIG. 3.

The optical pickup device further includes a wave plate 11, which is a λ/4 plate corresponding to a wavelength of about 660 nm and a wavelength of about 780 nm, and creates a difference of approximately 90 degrees between the polarization direction of the light traveling in an outgoing path and the polarization direction of the light traveling in a return path.

The erecting prism 12 reflects the incident laser light on a first surface 121 and then on a second surface 122, and the light reflected on the second surface 122 passes through the first surface 121 (see FIG. 2). This contributes to facilitating at least one of reduction in thickness and reduction in size of the optical pickup device, and also increases the rigidity of a later-described actuator.

The objective lens 13 is an objective lens adapted for an optical disk (DVD) 1 corresponding to a wavelength of about 660 nm, but has a function of focusing collimated light onto a desired recording point on an optical disk (CD) 1 corresponding to a wavelength of about 780 nm. In this embodiment, an arrangement is made such that the center of the objective lens 13 is substantially positioned on a center line M that extends along a direction of movement L of the carriage 4 and passes through the center of the spindle motor 2. It is to be noted that the direction of movement L of the carriage 4 coincides with a radial direction of the optical disk I held by the spindle motor 2, and may be referred to as a tracking direction.

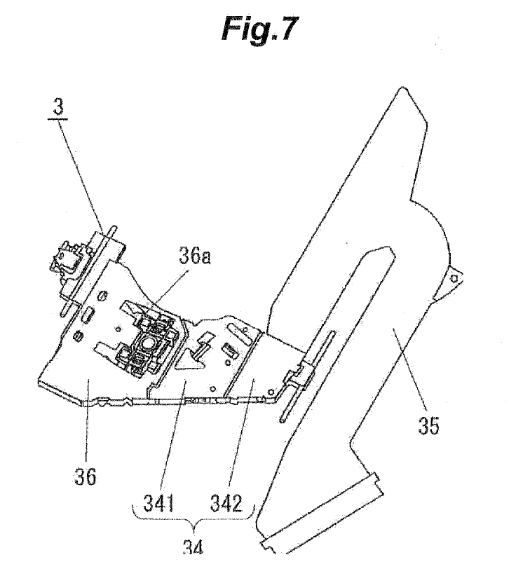

The optical pickup device further includes a laser driver 30, which has a function of turning on/off a laser diode with a wavelength of about 780 nm and a laser diode with a wavelength of about 660 nm which are incorporated in the laser unit 101, and a function of performing high-frequency superposition to reduce the noise in the light of each wavelength. The laser driver 30 is positioned close to a wiring member metallic cover sheet 34 (see FIG. 7) disposed on the upper side of the carriage 4 and a metallic cover sheet (not shown in the drawings) disposed on the underside of the carriage 4, such that heat can be dissipated effectively.

The wiring member 35 is provided to supply electric power to the laser unit 101, the light receiving element unit 102 and the optical monitor 31 mounted on the carriage 4, and is drawn out from a lateral end portion of the carriage 4 in parallel with the direction of movement L of the carriage 4, as shown in FIG. 1, to connect the component parts mounted on the carriage 4 with a power circuit (not shown in the drawings). Such a structure can reduce the load imposed on the wiring member 35 due to the tracking movement of the carriage 4.

Next, description will be made of the outgoing path of the laser light from the laser unit 101 to the objective lens 13.

The laser light 106 emitted from the laser unit 101 travels to the beam splitter 8 via a prism 105. The beam splitter 8 guides a part of the laser light 106 toward the optical monitor 31, and guides the rest of the laser light 106 toward the collimating lens 9. The optical monitor 31 receives the part of the laser light 106 and controls the quantity of the laser light 106 emitted from the laser unit 101. The erecting prism 12 guides the laser light 106 entering therein toward the objective lens 13. The objective lens 13 focuses the laser light 106 entering therein onto the recording surface of the optical disk 1 to reproduce information therefrom or record information thereon.

Next, description will be made of the return path of the laser light from the objective lens 13 to the light receiving element unit 102.

The light focused on the recording surface of the optical disk 1 by the objective lens 13 is partially reflected back to the objective lens 13. This reflected light enters the objective lens 13, and thereafter travels to the light receiving element unit 102 via the erecting prism 12, the collimating lens 9, the beam splitter 8 and the prism 105. The prism 105 is positioned on the optical path between the laser unit 101 and the objective lens 13 and held by the carriage 4. The prism 105 has a function of guiding the laser light 106 from the laser unit 101 toward the objective lens 13 and a function of guiding the return light from the objective lens 13 toward the light receiving element unit 102. The return light from the objective lens 13 is caused to travel to the light receiving element unit 102 by use of this function of the prism 105.

Next, description will be made of characteristic portions of the embodiment of the present invention.

The optical pickup device includes a protection cover 33 that covers a part of the wiring member 35 to prevent contact of the wiring member 35 with the optical disk 1, thereby protecting the wiring member 35. The protection cover 33 also covers the upper surface of the mount base 50 to protect various component parts mounted on the upper surface of the mount base 50, as shown in FIG. 8. Further, the protection cover 33 is provided with an opening 331 opposing the optical disk 1, and the laser light that has passed through the objective lens 13 is irradiated onto the optical disk 1 through this opening 331.

The laser unit 101, the objective lens 13 and the optical components such as the collimating lens 9 and the erecting prism 12 are all located within a region obtained by projecting the opening 331 in the protection cover 33 in a direction perpendicular to the disk surface of the optical disk 1, namely, located within a region defined by the opening 331 in the protection cover 33 as viewed in a direction perpendicular to the disk surface of the optical disk 1. According to this structure, the protection cover 33 covering the wiring member 35 does not include a part located above the laser unit 101, the objective lens 13 and the optical components, and therefore, while the protection cover 33 can protect the wiring member 35, it is not necessary to provide a space above the laser unit 101, the objective lens 13 and the optical components to prevent them from contacting the protection cover 33. Thus, with this structure, it is possible to realize an optical pickup device that enables reduction in thickness thereof even when the components of the device are arranged at a high density in the outgoing path of light from the laser unit 101 to the objective lens 13 and the device tends to have an increased thickness.

Further, as shown in FIG. 2, in the illustrated embodiment, the objective lens 13 protrudes into the opening 331 in the protection cover 33 such that the objective lens 13 is positioned at an elevation equal to or slightly higher than that of the protection cover 33, whereby the thickness of the optical pickup device is reduced as compared to a case where the objective lens 13 is disposed at an elevation lower than that of the protection cover 33. It is to be noted that the component parts other than the objective lens 13 which are located within the region defined by the opening 331 as viewed in the direction perpendicular to the disk surface of the optical disk 1 may additionally or alternatively be disposed to protrude into the opening 331, if necessary to reduce the thickness of the optical pickup device.

It is to be noted that the laser unit 101 has a function of emitting the laser light 106, the objective lens 13 has a function of focusing the laser light onto the optical disk 1, and the optical components are positioned on the optical path from the laser unit 101 to the objective lens 13 and have a function of guiding the laser light 106 to the objective lens 13. Further, the wiring member 35 is connected with the laser unit 101 to supply electric power to the laser unit 101.

The light receiving element unit 102 and the prism 105 also are located within the region obtained by projecting the opening 331 in the protection cover 33 in the direction perpendicular to the disk surface of the optical disk 1. According to this structure, the protection cover 33 covering the wiring member 35 does not include a part located above the light receiving element unit 102 and the prism 105, and therefore, while the protection cover 33 can protect the wiring member 35, it is not necessary to provide a space above the light receiving element unit 102 and the prism 105 to prevent them from contacting the protection cover 33. Thus, with this structure, it is possible to realize an optical pickup device that enables reduction in thickness thereof even when the components of the device are arranged at a high density in the return path of light from the objective lens 13 to the light receiving element unit 102 and the device tends to have an increased thickness.

It is to be noted that the light receiving element unit 102 has a function of receiving the return light reflected by the optical disk 1, and the prism 105 has a function of guiding the laser light 106 from the laser unit 101 toward the objective lens 13 and a function of guiding the return light from the objective lens 13 toward the light receiving element unit 102. Further, the carriage 4 has a function of holding the light receiving element unit 102 and the prism 105.

Further, the optical monitor 31 and the beam splitter 8 also are located within the region obtained by projecting the opening 331 in the protection cover 33 in the direction perpendicular to the disk surface of the optical disk 1. According to this structure, the protection cover 33 covering the wiring member 35 does not include a part located above the optical monitor 31 and the beam splitter 8, and therefore, while the protection cover 33 can protect the wiring member 35, it is not necessary to provide a space above the optical monitor 31 and the beam splitter 8 to prevent them from contacting the protection cover 33. Thus, with this structure, it is possible to realize an optical pickup device that enables reduction in thickness thereof even when the components of the device are arranged at a high density in the path of light from the laser unit 101 to the optical monitor 31 and the device tends to have an increased thickness.

It is to be noted that the optical monitor 31 has a function of receiving a part of the laser light 106 to control the quantity of the laser light 106 emitted from the laser unit 101, and the beam splitter 8 has a function of guiding a part of the laser light 106 from the laser unit 101 toward the optical monitor 31. The carriage 4 has a function of holding the optical monitor 31 and the beam splitter 8.

FIG. 3 is a fragmental enlarged view of the optical pickup device.

It is to be noted that the light receiving element unit 102 and the prism 105 in this embodiment correspond to the light receiving element and the prism of the present invention, respectively.

The laser unit 101 includes a laser diode 103 emitting laser light with a wavelength of about 660 nm and a laser diode 104 emitting laser light with a wavelength of about 780 nm, and these laser diodes 103 and 104 are mounted on a base 101a.

In this embodiment, the laser diodes 103 and 104 are disposed as separate light emitting blocks. However, it is also possible to employ a structure in which a plurality of light emitting layers is provided in a single light emitting block such that the single light emitting block is disposed. Further, while two laser diodes with different wavelengths are incorporated in this embodiment, one or more than two laser diodes with different wavelengths may be provided.

The base 101a has a plurality of terminals 101b extending vertical to the same. The terminals 101b include a grounding terminal, terminals for supplying electric current to the laser diodes 103 and 104, an output terminal for the monitor light, and so on.

In this embodiment, two laser diodes are provided and detailed description will be made thereof in the following.

The prism 105 allows the laser light 106 to pass therethrough and guides the return light toward the light receiving element unit 102. The prism 105 has slant surfaces 105a-105c which are slanted substantially in parallel with one another. On the slant surfaces 105a-105c are arranged optical elements including a beam splitter film and a hologram. Specifically, the slant surface 105a is provided with a reflection film and a hologram (not shown in the drawings) such that functions for carrying out focus detection, tracking detection, and detection of signals recorded on the optical disk 1 and control signals, etc. are realized. The slant surface 105b has a film formed thereon such that the film allows P-wave light to pass therethrough and reflects S-wave light by functioning as a polarization beam splitter with respect to a wavelength of about 660 nm and partially transmits and partially reflects light with respect to a wavelength of about 780 nm. The slant surface 105c has a film formed thereon such that the film allows only P-wave light to pass therethrough and reflects S-wave light by functioning as a polarization beam splitter with respect to wavelengths of about 660 nm and about 780 nm.

The slant surfaces 105a-105c are equivalent to junction planes between transparent glass blocks or resin blocks. Although three slant surfaces are provided in this embodiment, one or more of slant surfaces may be provided.

A diffraction grating 108 for forming three beams is provided on a side of the prism 105 close to the laser unit 101, as required. The diffraction grating 108 is fabricated of a single plate and realizes a three-beam diffraction grating including a uniform diffraction grating for a wavelength of about 780 nm and a diffraction grating divided into two parts for a wavelength of about 660 nm. It is to be noted that while the diffraction grating is fabricated of a single plate in this embodiment, the diffraction grating may of a type that utilizes polarization and is constituted of a plurality of plate members stacked one over another, for example, such that the laser light with one wavelength is not affected by the laser light with the other wavelength.

A connecting member 107 is provided as a member for determining the positions of the laser unit 101 and the light receiving element unit 102.

The light emitted from either the laser diode 103 or the laser diode 104 passes through the diffraction grating 108 and the prism 105, and is guided to the optical disk 1. The light reflected by the optical disk 1 is guided to the light receiving element unit 102 via the prism 105. At this time, in the prism 105, the reflected light from the optical disk 1 is reflected between the slant surfaces 105b and 105a, before entering the light receiving element unit 102.

The light receiving element unit 102 includes alight receiving element 102a covered by a case 102b containing a transparent member, and a terminal (not shown in the drawings) electrically connected to the light receiving element 102a is provided to extend out from the case 102b.

The optical monitor 31 includes a light receiving element 31a covered by a case 31b containing a transparent member, and a terminal (not shown in the drawings) electrically connected to the light receiving element 31a is provided to extend out from the case 31b.

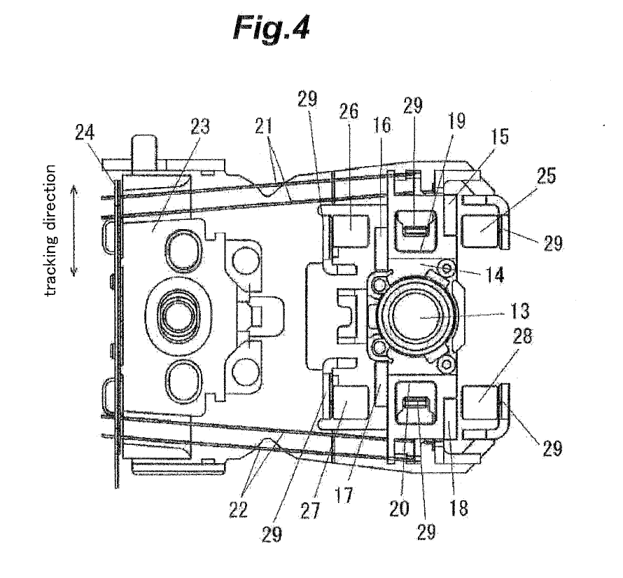

Next, description will be made of the actuator holding the objective lens 13 with reference to FIGS. 4, 5 and 6.

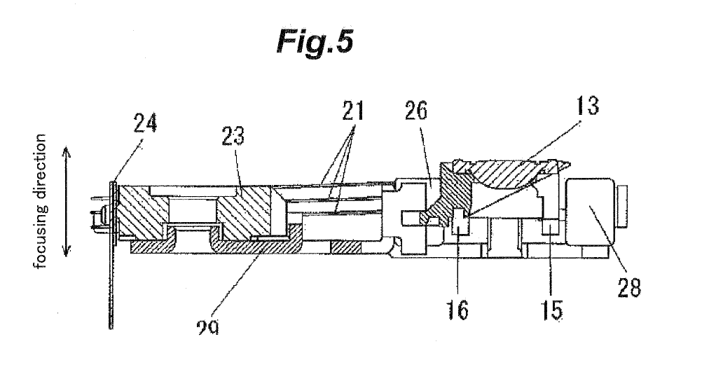

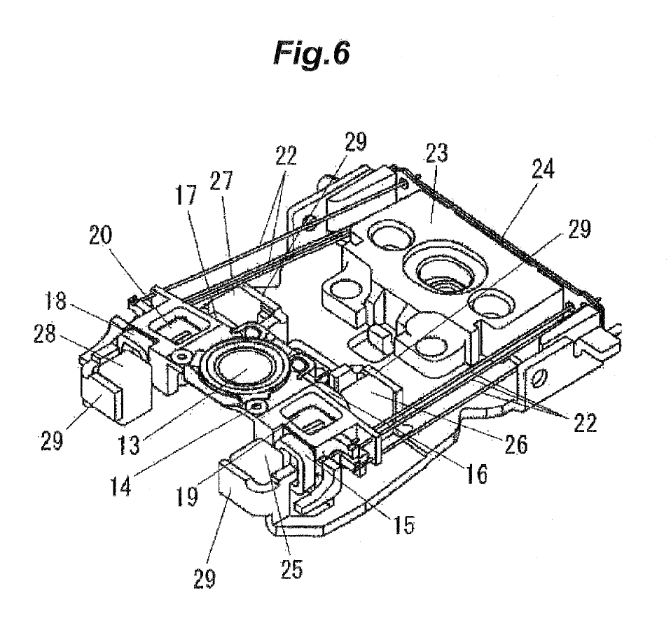

FIG. 4 is a plan view showing an actuator of the optical pickup device, FIG. 5 is s cross-sectional view of the actuator of the optical pickup device, and FIG. 6 is a perspective view showing the actuator of the optical pickup device.

In FIGS. 4, 5 and 6, an objective lens holding cylinder 14 securely holds the objective lens 13 by means such as adhesion.

Focus coils 19 and 20 are each wound in a substantially ring-like shape. Tracking coils 15, 16, 17 and 18 also are each wound in a substantially ring-like shape in the same manner as the focus coils 19 and 20. The focus coils 19 and 20 and the tracking coils 15, 16, 17 and 18 are also fixed to the objective lens holding cylinder 14 with an adhesive or the like. Suspension wires 21 and 22 couple the objective lens holding cylinder 14 to a suspension holder 23, such that at least the objective lens holding cylinder 14 can be moved with respect to the suspension holder 23 within a predetermined range. The two ends of each of the suspension wires 21 and 22 are fixed to the objective lens holding cylinder 14 and the suspension holder 23, respectively, by means of soldering, welding, adhesion, or the like. The focus coil 19 and the tracking coil 15 also are fixed to the suspension wire 21 by means of soldering or the like, and the focus coil 20 and the tracking coil 18 also are connected electrically to the suspension wire 22 by means of soldering or the like. The suspension wires 21 and 22 are preferably constituted of at least six round wires or leaf springs in such a manner that electric power can be supplied to each of the focus coils 19 and 20 as well as to each of the tracking coils 15, 16, 17 and 18 bonded in series. In this embodiment, the actuator includes three suspension wires 21 and three suspension wires 22 in a staggered arrangement, and this contributes to achieving at least one of reduction in thickness and reduction in size of the optical pickup device.

The suspension holder 23 has a flexible board 24 fixed thereto by means of adhesion or the like, and the suspension wires 21 and 22 are fixed to the flexible board 24 by means of soldering or the like. Magnets 25, 26, 27 and 28 are magnets for focusing and tracking, and each of them has a smaller width (dimension in the tracking direction) than that of the focusing coils 19 and 20. As shown in FIG. 4, the coil center position of the focusing coil 19 coincides in the tracking direction with the center position of each of the magnets 25 and 26, while the coil center position of the focusing coil 20 coincides in the tracking direction with the center position of each of the magnets 27 and 28. A tracking coil 15 is disposed at a position displaced from the magnet 25 toward the inner periphery of the optical disk 1, a tracking coil 16 is disposed at a position displaced from the magnet 26 toward the outer periphery of the optical disk 1, a tracking coil 17 is disposed at a position displaced from the magnet 27 toward the inner periphery of the optical disk 1, and a tracking coil 18 is disposed at a position displaced from the magnet 28 toward the outer periphery of the optical disk 1. Each of the magnets 25, 26, 27 and 28 has magnetic poles segmented in a direction perpendicular to the tracking direction. Namely, each of the magnets 25, 26, 27 and 28 is disposed such that one pole thereof is opposed to a substantially ring-shaped piece of a corresponding one of the tracking coils 15, 16, 17 and 18. In this state, the magnets 25, 26, 27 and 28 and a magnetic yoke 29 form focus magnetic circuits and tracking magnetic circuits, such that the focusing coils 19 and 20 are disposed in the corresponding focus magnetic circuits while the tracking coils 15, 16, 17 and 18 are disposed in the corresponding tracking magnetic circuits, such that one coil is disposed in each magnetic circuit. Thus, the coils can be controlled independently if each coil can be energized individually.

In this embodiment, description is made with an assumption that the focusing coils 19 and 20 can be controlled independently. However, the structure may be adapted to allow all of the focusing coils 19 and 20 and the tracking coils 15, 16, 17 and 18 to be controlled independently. In this case, the suspension wires 21 and 22 are required at least twelve in total.

The magnetic yoke 29 magnetically plays a role of a magnetic yoke for the magnets 25, 26, 27 and 28, and structurally serves a function of holding and fixing the suspension holder 23. The magnetic yoke 29 is also utilized in fixing the suspension holder 23 by an adhesive or the like. A part of each suspension wire 21, 22 close to the suspension holder 23 is filled with a damper gel for damping. The damper gel is fabricated by use of a material that transitions to a gel state when irradiated by UV or the like. Incidentally, the part constituted by the objective lens holder cylinder 14, the focusing coils 19 and 20, the tracking coils 15-18 and the objective lens 13 is hereinafter referred to as an optical pickup actuator movable part.

Now, with reference to FIGS. 1 to 3, explanation will be made of the optical structure of the optical pickup device in this embodiment.

First, description will be made of a structure relating to the light with a wavelength of about 660 nm.

The laser light 106 having a wavelength of about 660 nm emitted from the laser diode 103 of the laser unit 101 passes the diffraction grating 108 to form three beams, which pass through the prism 105, are reflected by the beam splitter 8, and then are converted into substantially collimated light by the collimating lens 9. The substantially collimated laser light 106 after passing through the collimating lens 9 passes through the wave plate 11 and turns into substantially circular polarization light, and then, is reflected by the first surface 121 and the second surface 122 of the erecting prism 12. The reflected laser light 106 is condensed by the objective lens 13 to form a light spot on the optical disk 1.

The laser light 106 returning from the optical disk 1 enters the wave plate 11 in the direction opposite to the direction in which the laser light 106 traveling in the outgoing path entered the wave plate 11, and passes through the wave plate 11, whereby the polarization direction is shifted by approximately 90 degrees relative to the laser light traveling in the outgoing path. Subsequently, the return laser light is reflected by the slant surface 105b in the prism 105, then by the slant surface 105a, and again by the slant surface 105b, before being guided to the light receiving element 102a in the light receiving element unit 102. Besides, a part of the laser light 106 emitted from the laser diode 103 passes through the beam splitter 8, and is guided to the optical monitor 31. The optical monitor 31 monitors the quantity of the received laser light 106, and adjusts the output level of the laser light 106 emitted from the laser diode 103.

Next, description will be made of a structure relating to the light with a wavelength of about 780 nm.

The laser light 106 having a wavelength of about 780 nm emitted from the laser diode 104 of the laser unit 101 passes the diffraction grating 108 to form three beams, which pass through the prism 105, are reflected by the beam splitter 8, and then are converted into substantially collimated light by the collimating lens 9. The substantially collimated laser light 106 after passing through the collimating lens 9 passes through the wave plate 11 and turns into substantially circular polarization light, and then, is reflected by the first surface 121 and the second surface 122 of the erecting prism 12. The reflected laser light 106 is condensed by the objective lens 13 to form a light spot on the optical disk 1. The laser light 106 returning from the optical disk 1 enters the wave plate 11 in the direction opposite to the direction in which the laser light 106 traveling in the outgoing path entered the wave plate 11, and passes through the wave plate 11, whereby the polarization direction is shifted by approximately 90 degrees relative to the laser light traveling in the outgoing path. Subsequently, the return laser light is reflected by the slant surface 105b in the prism 105, then by the slant surface 105a, and again by the slant surface 105b, before being guided to the light receiving element 102a in the light receiving element unit 102. Besides, a part of the laser light 106 emitted from the laser diode 104 passes through the beam splitter 8, and is guided to the optical monitor 31. The optical monitor 31 monitors the quantity of the received laser light 106, and adjusts the output level of the laser light 106 emitted from the laser diode 104.

Now, with reference to FIGS. 4, 5 and 6, explanation will be made of the operation of the optical pickup actuator movable part of this embodiment.

Electric power is supplied from a power source (not shown in the drawings) to the focusing coils 19 and 20 and the tracking coils 15, 16, 17 and 18 through the flexible board 24 attached on the suspension holder 23 and the suspension wires 21 and 22 connected to the flexible board 24. The suspension wires 21 and 22 are provided at least six or more in total, and two of them are connected to the tracking coils 15, 16, 17 and 18, which are connected in series, and two of the remaining four are connected to the focusing coil 19, and the remaining two are connected to the focusing coil 20. This makes it possible to control the energization of the focusing coils 19 and 20 independently from each other.

When a current is caused to flow through the focusing coils 19 and 20 both in the positive direction (or in the negative direction), focus magnetic circuits are formed for movement in a focusing direction, according to the arrangement relationship of the focusing coils 19, 20 and the magnets 25, 26, 27 and 28 and the relationship of the polarities of their magnetic poles. This enables control in the focusing direction depending upon a direction and amount of current flow. Then, when a current is caused to flow through the tracking coils 15, 16, 17 and 18 in the positive direction (or in the negative direction), tracking magnetic circuits are formed for movement in a tracking direction, according to the arrangement relationship of the tracking coils 15, 16, 17 and 18 and the magnets 25, 26, 27 and 28 and the relationship of the polarities of their magnetic poles. This enables control in the tracking direction.

As described in the foregoing, in this embodiment, a current can be caused to flow independently through the focusing coil 19 and the focusing coil 20. Accordingly, when the current flowing through one of the coils 19 and 20 is inverted in direction, the focusing coil 19 is acted upon by a force in a direction toward the optical disk 1 while the focusing coil 20 is acted upon by a force in a direction away from the optical disk 1, for example. As a result, the opposite forces produce a moment acting on the optical pickup actuator movable part to rotate it around an axis perpendicular to the tracking direction and the focusing direction, thereby causing the optical pickup actuator movable part to tilt until it reaches a position where the moment caused by the focusing coils 19 and 20 balances with a twist moment caused by the six suspension wires 21 and 22. Thus, the direction and amount of tilt can be controlled by controlling the direction and amount of a current flowing through the focusing coils 19 and 20.

Next, description will be made of the objective lens 13.

The objective lens 13 preferably has a numerical aperture of 0.65 to 0.66 and a focal length of 1.5 mm to 1.65 mm for a wavelength of about 660 nm. If the numerical number is outside the range of 0.65 to 0.66, it disadvantageously affects recording and reproduction of information on and from the optical disk 1 (DVD). If the focal length is too short, it disadvantageously affects the performance of the optical pickup 3 due to the eccentricity of the optical disk 1, and if the focal length is too long, it leads to increase in the diameter of the objective lens 13. This in turn would require increase in the diameter of the substantially collimated light incident on the objective lens 13, and therefore, it would become necessary to increase the size of other component parts such as the erecting prism 12 and the collimating lens 9. This is disadvantageous in reducing the thickness or size of the optical pickup device. By using the objective lens 13 having a focal length set forth above, it is possible to achieve at least one of reduction in thickness and reduction in size of the optical pickup device.

Further, it is preferred that the objective lens 13 have its center positioned substantially on the center line M extending along the moving direction L of the carriage 4 and passing the center of the spindle motor 2, as shown in FIG. 1. Namely, with such a structure, it is possible to employ a three-beam DPP (differential push-pull) method, which is used most commonly as a conventional optical detecting method.

Next, description will be made of the relationship between the optical pickup and the protection cover. The protection cover 33 extends substantially in parallel with the disk surface of the optical disk 1 to cover the carriage 4, the support shaft 6, the guide shaft 7 and other component parts mounted on the mount base 50, and is provided with the opening 331 opposing the optical disk 1.

FIG. 7 is a perspective view showing the optical pickup device, and FIG. 8 is a drawing showing a structure of an optical pickup module. It is to be noted that the protection cover 33 and the opening 331 in this embodiment correspond to the protection cover and the opening in the protection cover of the present invention.

The upper surface of the optical pickup 3 is covered by the wiring member metallic cover sheet 34 and au actuator cover 36, where the actuator cover 36 is provided with an opening 36a which exposes at least the objective lens 13. The wiring member metallic cover sheet 34 includes a first flat section 341 and a second flat section 342.

The wiring member 35 is connected with the laser unit 101, the light receiving element unit 102 and the optical monitor 31. This wiring member 35 may consist of a single wiring member or may include a plurality of wiring members. The wiring member 35 may be realized by use of a flexible printed circuit (FPC) or may be realized as a flat cable including a bundle of lead wires. The wiring member 35 is flexible and can bend easily so as not to interfere with the tracking movement of the carriage 34.

An optical pickup module 32 includes the protection cover 33, the spindle motor 2 and the optical pickup 3, and is configured to be capable of moving the optical pickup 3 toward and away from the spindle motor 2 in the direction indicated by an arrow in FIG. 8.

The wiring member 35 is drawn out from under the second flat section 342 and is connected with an optical disk device. In this embodiment, the wiring member 35 is drawn out from a portion of the carriage 4 between the laser unit 101 and the guide shaft 7. In such a structure, the wiring member 35 is displaced laterally from the laser unit 101, the objective lens 13 and the optical components therebetween (namely, the prism 105, the beam splitter 8 and the collimating lens 9), and therefore, a space for accommodating the wiring member 35 does not overlap above or below these component parts. Thus, the thickness of the optical pickup device can be reduced. Further, it is possible to ensure that the wiring member 35 does not interfere with the optical path between the laser unit 101 and the objective lens 13.

The first flat section 341 is disposed in the opening 331, while the second flat section 342 is disposed beneath the protection cover 33. Since the first flat section 341 is disposed in the opening 331, it can be placed closer to the optical disk 1 than the second flat section 342. For example, the first flat section 341 may be disposed at substantially the same elevation as that of the protection cover 33, or may be disposed so as to slightly protrude over the upper surface of the protection cover 33 so long as the first flat section 341 does not contact the underside of the optical disk 1.

The laser unit 101, the light receiving element unit 102 and the optical monitor 31 are disposed on the underside of the first flat section 341. Also, the laser unit 101, the light receiving element unit 102, the optical monitor 31, the beam splitter 8, the collimating lens 9, the wave plate 11, the erecting prism 12 and the objective lens 13 are disposed in the opening 331.

It is to be noted that, though in this embodiment the laser unit 101, the light receiving element unit 102 and the optical monitor 31 are disposed on the underside of the first flat section 341, it is possible to adopt a structure in which the laser unit 101 and the light receiving element unit 102 are disposed on the underside of the first flat section 341. Further, while in this embodiment the laser unit 101, the light receiving element unit l 02, the optical monitor 31, the beam splitter 8, the collimating lens 9, the wave plate 11, the erecting prism 12 and the objective lens 13 are disposed in the opening 331, it is possible to adopt a structure in which the laser unit 101, the light receiving element unit 102, the beam splitter 8, the collimating lens 9, the erecting prism 12 and the objective lens 13 are disposed in the opening 331.

By adopting such a structure, it is possible to achieve reduction in thickness and/or size of the optical pickup 3 without need for reducing the thickness and/or size of the laser unit 101, the light receiving element unit 102, the optical monitor 31, the beam splitter 8, the collimating lens 9, the erecting prism 12 and the objective lens 13.

Further, by mounting the above-described optical pickup module 32 to an optical disk device equipped with an optical disk rotation drive unit for rotating the optical disk 1, it is possible to realize an optical disk device that enables reduction in thickness and/or size thereof.

The optical pickup device according to the present invention can have a reduced thickness, and thus, may be favorably used as an optical pickup device incorporated in electronic devices such as personal computers, laptop computers and mobile terminal devices.

Although the present invention has been described in terms of preferred embodiments thereof, it is obvious to a person skilled in the art that various alterations and modifications are possible without departing from the scope of the present invention which is set forth in the appended claims.

The contents of the original Japanese patent application(s) on which the Paris Convention priority claim is made for the present application as well as the contents of the prior art references mentioned in this application are incorporated in this application by reference.

1. An optical pickup device, comprising:
a mount base having an upper surface;
a rotation drive unit mounted on the mount base and configured to hold and rotate an optical disk;
a carriage supported on the upper surface of the mount base so as to be moveable radially relative to the optical disk held by the rotation drive unit;
a light source mounted on the carriage and configured to emit laser light;
a light condensing member mounted on the carriage and configured to condense the laser light onto the optical disk held by the rotation drive unit;
a plurality of optical components mounted on the carriage so as to be located on an optical path from the light source to the light condensing member and configured to guide the laser light to the light condensing member;
a wiring member that connects the light source with a power circuit to supply electric power to the light source; and
a protection cover that covers the upper surface of the mount base and a part of the wiring member and is provided with an opening opposing the optical disk 1 and allowing the laser light that has passed through the light condensing member to be irradiated onto the optical disk through the opening,
wherein the light source, the light condensing member and the optical components are located within a region obtained by projecting the opening in the protection cover in a direction perpendicular to a disk surface of the optical disk, and at least one of the light source, the light condensing member and the optical components protrudes into the opening in the protection cover.

2. The optical pickup device according to claim 1, further comprising:
a light receiving element that receives return light reflected by the optical disk; and
a prism that guides the laser light from the light source toward the light condensing member and guides the return light from the light condensing member toward the light receiving element,
wherein the carriage holds the light receiving element and the prism, and wherein the light receiving element and the prism are located within the region obtained by projecting the opening in the protection cover in the direction perpendicular to the disk surface of the optical disk.

3. The optical pickup device according to claim 2, further comprising:
an optical monitor that receives a part of the laser light to control a quantity of laser light emitted from the light source; and
a beam splitter that guides a part of the laser light from the light source toward the light monitor,
wherein the carriage holds the optical monitor and the beam splitter, and wherein the optical monitor and the beam splitter are located within the region obtained by projecting the opening in the protection cover in the direction perpendicular to the disk surface of the optical disk.

4. The optical pickup device according to claim 1, further comprising a first shaft and a second shaft that support respective ends of the carriage such that the carriage is movable,
wherein the first shaft is positioned on a side of the carriage relatively close to the light source and the second shaft is positioned on a side of the carriage relatively close to the light condensing member, and wherein the wiring member is drawn out from a portion of the carriage between the light source and the first shaft.

5. The optical pickup device according to claim 4, wherein the wiring member is drawn out from a lateral end portion of the carriage in parallel with a direction of movement of the carriage.

6. The optical pickup device according to claim 1, further comprising a metallic cover sheet having a flat section located in the opening in the protection cover such that the light source is disposed on an underside of the flat section of the metallic cover sheet, wherein the flat section of the metallic cover sheet is disposed at a substantially same elevation as the protection cover or is disposed so as to slightly protrude over an upper surface of the protection cover.
